(19) United States
(12) Patent Application Publication
(10) Pub. No.: US 2008/0075927 A1
(43) Pub. Date: Mar. 27, 2008

(54) Functional Film Containing Structure And Method Of Manufacturing Functional Film

(75) Inventor: Yukio Sakashita, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFLIM CORPORATION, TOKYO JAPAN (JP)

(21) Appl. No.: 11/664,080

(22) PCT Filed: Jun. 5, 2006
(86) PCT No.: PCT/JP06/11673

§ 371 Date: Mar. 29, 2007

(30) Foreign Application Priority Data
Jun. 7, 2005 (JP) 2005-166407

(51) Int. Cl. B32B 3/00; B05D 3/00; B05D 3/10; B05D 5/12; B32B 9/04; B32B 15/04; B32B 17/06

(52) U.S. Cl. 428/172; 427/127; 427/309; 427/331; 427/58; 427/62; 428/411.1; 428/426; 428/454; 428/457; 428/688; 428/689; 428/698; 428/702

(57) ABSTRACT

A method of manufacturing a functional film by which a functional film formed on a film formation substrate can be easily peeled from the film formation substrate. The method includes the steps of: (a) forming a separation layer (102) on a substrate (101); (b) forming a layer to be peeled (103, 105, 106) containing a functional film (103, 105b, 106a), which is formed by using a functional material, on the separation layer (102); and (c) applying an external force to the separation layer (102) to produce fracture within the separation layer (102) or at an interface thereof so as to peel the layer to be peeled (103, 105, 106) from the substrate (101) or reduce bonding strength between the layer to be peeled (103, 105, 106) and the substrate (101).

### TECHNICAL FIELD

The present invention relates to a method of manufacturing a functional film including a dielectric material, piezoelectric material, pyroelectric material, magnetic material, semiconductor material or the like, and a functional film containing structure to be used in a manufacturing process of the functional film.

### BACKGROUND ART

Recent years, in response to the needs for electronic devices such as miniaturization, speeding up, integration, and multifunctionality, the manufacture of devices containing functional materials such as electronic ceramics, which express predetermined functions by being applied with electric fields or magnetic fields and include a dielectric material, piezoelectric material, magnetic material, pyroelectric material and semiconductor material, by using various film formation technologies has been actively studied.

For example, in order to enable high-definition and high-quality printing in an inkjet printer, it is necessary to miniaturize and highly integrate ink nozzles of inkjet heads. Accordingly, it is also necessary to similarly miniaturize and highly integrate piezoelectric actuators for driving the respective ink nozzles. In such a case, a film formation technology, that enables formation of a thinner layer than a bulk material and formation of fine patterns, is desired, and film formation technologies such as a sputtering method, a sol-gel method, and an aerosol deposition method have been studied.

However, there has been a problem that a film of function material (also simply referred to as “functional film”) formed by film formation does not sufficiently exert its function in a condition after the film formation, and the film is inferior to a bulk material in performance.

In order to sufficiently express the function of a functional film, heat treatment at relatively high temperature (e.g., about 500° C. to 1000° C.) is required after film formation. Since a substrate that is used at the time of film formation (film formation substrate) is simultaneously heat-treated, high heat tolerance is required for the material of film formation substrate. On the other hand, in the case where a fabricated function film is utilized, there is demand for using various kinds of substrates according to instruments such as a flexibly substrate made of resin, for example. Accordingly, a method has been studied by which a functional film formed on a film formation substrate can be peeled or transferred from the film formation substrate without hindering its function.

As a related technology, Japanese Patent Application Publication JP-A-54-94905 discloses a multilayered structure for thin film transfer having a heat-resistant substrate, a release layer principally containing carbon and/or carbon compound, and a functional thin film as main component elements (page 1). Further, JP-A-54-94905 discloses that the functional thin film can be peeled from the heat-resistant substrate and transferred to another substrate because the release layer can be removed by oxidization (combustion) (page 3).

Japanese Patent Application Publication JP-A-10-125929 discloses a peeling method by which any material to be peeled can be easily peeled regardless of its properties and conditions, and especially, the peeled material can be transferred to various transfer materials. The peeling method is to peel a material to be peeled existing on a substrate via a separation layer having a multilayered structure of plural layers from the substrate, and includes the steps of applying irradiating light to the separation layer to cause peeling within the layer of the separation layer and/or at an interface thereof so as to detach the material to be peeled from the substrate (pages 1 and 2). Further, in JP-A-10-125929, as the composition of a light absorption layer, amorphous silicon, silicon oxide, dielectric material, nitride ceramics, organic polymer and so on are cited (pages 5 and 6).

Japanese Patent Application Publication JP-P2004-165679A discloses a method of transferring a layer to be transferred containing a thin film device to a secondary transfer material, which method is for matching (i) a multilayer relationship of the layer to be transferred against a substrate used when the layer to be transferred is manufactured and (ii) a multilayer relationship of the layer to be transferred against a transfer material as a transfer destination of the layer to be transferred. The method includes the first step of forming a first separation layer on a substrate, the second step of forming a layer to be transferred containing a thin film device on the first separation layer, the third step of forming a second separation layer consisting of a water-soluble or organic solvent-soluble adhesive agent on the layer to be transferred, the fourth step of bonding a primary transfer material onto the second separation layer, the fifth step of removing the substrate from a material to be transferred by using the first separation layer as a boundary, the sixth step of bonding a secondary transfer material to an undersurface of the layer to be transferred, and the seventh step of bringing the second separation layer into contact with water or organic solvent to remove the primary transfer material from the transfer layer by using the second separation layer as a boundary (pages 1 and 2). Further, in JP-P2004-165679A, as the composition of the separation layer, amorphous silicon, silicon oxide, dielectric material, nitride ceramics, organic polymer and so on are cited (pages 8 and 9).

However, according to JP-A-54-94905, since the release layer is removed by oxidation reaction, the atmosphere in the heat treatment process is limited to an oxygen atmosphere. Further, since carbon or carbon compound is used as the release layer, there is the upper limit to heating temperature. For example, in an embodiment disclosed in JP-A-54-94905 (pages 1 and 3), the treatment temperature in the transfer process is 630° C. at the highest. Therefore, the invention disclosed in JP-A-54-94905 cannot be applied to a manufacture of electronic ceramics that requires heat treatment at relatively high temperature (e.g., 900° C. or more).

According to JP-A-10-125929, peeling is caused within the separation layer by applying a laser beam to a light absorption layer contained in the separation layer to allow the light absorption layer to ablate. Here, “ablation” means that a solid material contained in the light absorption layer is photochemically or thermally excited by absorbing the applied light, and thereby, bonding between atoms or molecules of the surface or inside thereof is cut and they are released. The ablation principally appears as a phenomenon that a phase change such as melting or transpiration (vaporization) occurs in the constituent material of the light absorption layer. According to the method, although the material to be peeled can be peeled from the substrate at relatively low temperature, the peeling property is likely to be insufficient.

On the other hand, according to JP-P2004-165679A, when the thin film device is detached from the substrate by applying a laser beam to the separation layer, in order to peel the thin film device from the substrate more reliably, ions for promoting peeling are implanted into the separation layer. According to such a method, inner pressure is generated in the separation layer and the peeling phenomenon is promoted. However, since hydrogen ions cited as ions for promoting peeling in JP-P2004-165679A are gasified at 350° C. or more and exit from the separation layer (page 6), the process temperature after ion implantation can not be set to 350° C. or more.

### DISCLOSURE OF THE INVENTION

In view of the above-mentioned problems, a first purpose of the present invention is to provide a method of manufacturing a functional film by which a functional film formed on a film formation substrate can be easily peeled from the film formation substrate. Further, a second purpose of the present invention is to provide a functional film containing structure to be used in a manufacturing process of such a functional film.

In order to accomplish the purposes, a functional film containing structure according to one aspect of the present invention includes: a substrate; a separation layer provided on the substrate; and a layer to be peeled provided on the separation layer and containing a functional film formed by using a functional material, wherein the layer to be peeled is peeled from the substrate or bonding strength between the layer to be peeled and the substrate becomes lower by applying an external force to the separation layer to produce fracture within the separation layer or at an interface thereof.

Further, a method of manufacturing a functional film according to one aspect of the present invention includes the steps of: (a) forming a separation layer on a substrate; (b) forming a layer to be peeled containing a functional film, which is formed by using a functional material, on the separation layer; and (c) applying an external force to the separation layer to produce fracture within the separation layer or at an interface thereof so as to peel the layer to be peeled from the substrate or reduce bonding strength between the layer to be peeled and the substrate.

According to the present invention, the separation layer that easily fractures by being applied with an external force is provided between the substrate and the layer to be peeled containing the functional film, and therefore, the substrate and the functional film can be peeled with a little force. Accordingly, the functional film formed on the substrate by using a film formation technology at a relatively higher temperature (e.g., 350° C. or more) can be easily transferred to a flexible substrate or the like having relatively low heat tolerance at a lower temperature (e.g., about 10° C. to 100° C.) and utilized. Therefore, elements having advantageous properties can be suitably mounted on instruments according to application and the performance of the entire instruments utilizing such elements can be improved.

### BRIEF DESCRIPTION OF THE DRAWINGS

Advantages and features of the present invention will be apparent by considering the following detailed description and the drawings in relation. In these drawings, the same reference numerals indicate the same component elements.

FIG. 1 is a flowchart showing a method of manufacturing a functional film according to the first embodiment of the present invention.

FIGS. 2A to 2E are sectional views for explanation of the method of manufacturing a functional film according to the first embodiment of the present invention.

FIG. 3 is a sectional view showing a functional film transferred to a substrate for transfer.

FIG. 4 is a sectional view showing a modified example of a functional film containing structure.

FIG. 5 is a sectional view showing another modified example of the functional film containing structure.

FIGS. 6A to 6D are diagrams for explanation of a method of manufacturing a functional film according to the second embodiment of the present invention.

### BEST MODE FOR CARRYING OUT THE INVENTION

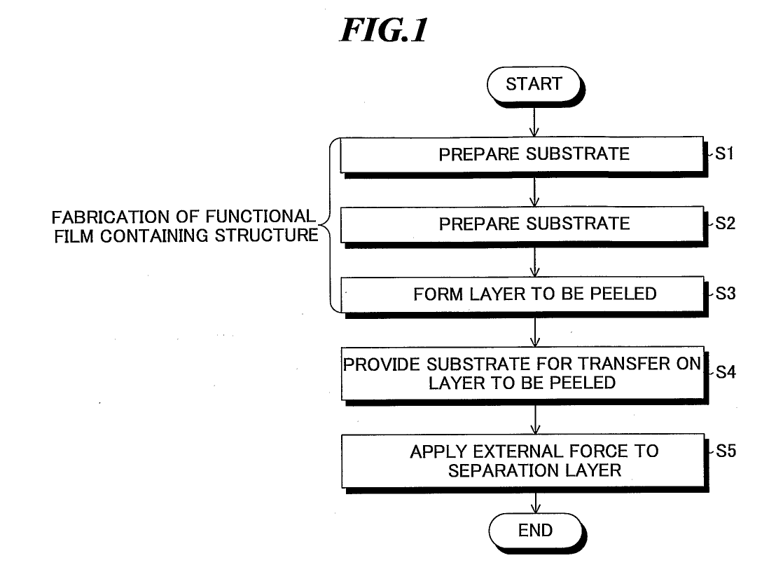

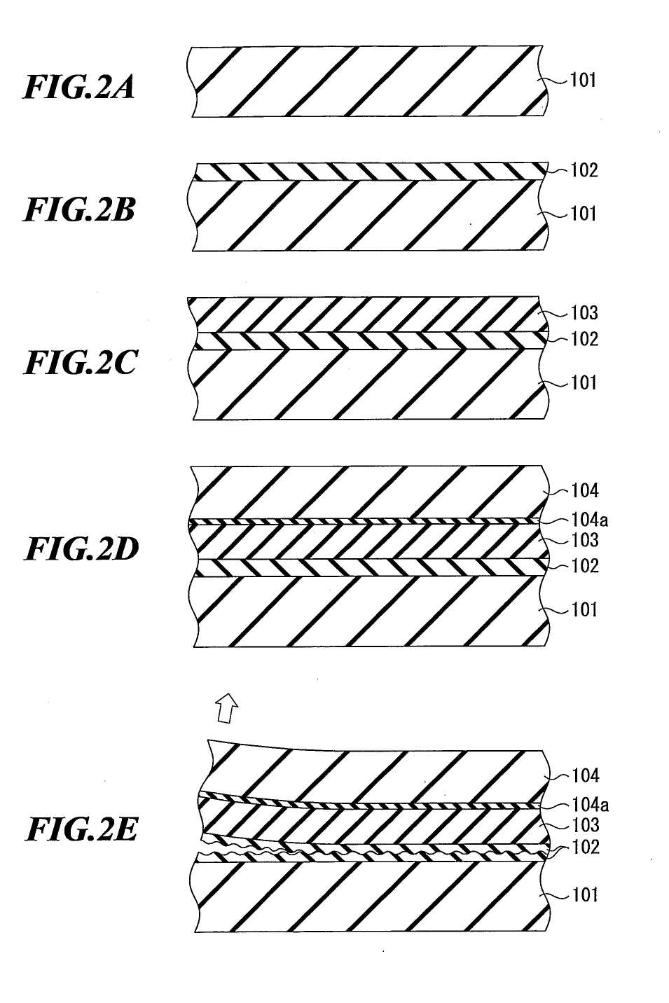

FIG. 1 is a flowchart showing a method of manufacturing a functional film according to the first embodiment of the present invention. Further, FIGS. 2A to 2E are diagrams for explanation of the method of manufacturing a functional film according to the first embodiment of the present invention, in which FIGS. 2A to 2C show steps of fabricating a functional film containing structure according to the first embodiment of the present invention.

First, at step S1 in FIG. 1, a substrate 101 is prepared as shown in FIG. 2A. The substrate 101 is a substrate for film formation to be used in the manufacturing process of the functional film. As the substrate 101, selection is desirably made in consideration of heat tolerance to the process temperature at the subsequent film formation process and the heat treatment process to be performed according to need and so on. For example, a single crystal substrate including a semiconductor single crystal substrate and an oxide single crystal substrate, a ceramic substrate, a glass substrate or a metal substrate is used.

As an oxide single crystal substrate material, specifically, magnesium oxide (MgO), alumina (Al₂O₃), titanium oxide (TiO₂), zinc oxide (ZnO), spinel (magnesium aluminate, MgAl₂O₄), strontium titanate (SrTiO₃), lanthanum aluminate (LaAlO₃), lithium niobate (LiNbO₃), lithium tantalate (LiTaO₃) and so on are cited. In the case where the oxide single crystal substrate material is used, by selecting a material having a predetermined lattice constant according to a functional film as a target of manufacturing, the functional film can be formed by epitaxial growth. Further, since these substrates are stable in an oxidizing atmosphere, they can be used for film formation or heat-treated at high temperature (e.g., about 1000° C. for magnesium oxide) in the air atmosphere.

As a semiconductor single crystal substrate material, specifically, silicon (Si), germanium (Ge), gallium arsenide (GaAs), gallium phosphide (GaP), indium phosphide (InP) and so on are cited. In the case where the semiconductor single crystal substrate material is used, by selecting a material having a predetermined lattice constant according to a functional film as a target of manufacturing, the functional film can be formed by epitaxial growth. Further, since these substrates are stable in a reducing atmosphere, they can be used for film formation or heat-treated at high temperature (e.g., about 1000° C. for silicon) in the reducing atmosphere.

As a ceramic substrate material, alumina (Al₂O₃), zirconia (ZrO₂), aluminum nitride (AlN) and so on are cited. Since the ceramic substrate is more inexpensive than the single crystal substrate, the cost of manufacturing can be reduced. Further, since these substrates are stable in the air atmosphere and have high heat tolerance, they can be used for film formation or heat-treated at high temperature (e.g., about 1100° C. for alumina) in the air atmosphere.

As a glass substrate material, specifically, silicate glass, alkaline silicate glass, borosilicate glass, soda-lime glass, lead glass and so on are cited. Since the glass substrate is more inexpensive than the single crystal substrate, the cost of manufacturing can be reduced. Further, since these substrates are stable in an oxidizing atmosphere, they can be used for film formation or heat-treated at high temperature (e.g., about 900° C. for silicate glass) in the air atmosphere.

As a metal substrate material, specifically, metal such as platinum (Pt), copper (Cu), nickel (Ni), iron (Fe) and so on, and alloy such as stainless are cited. Since the metal substrate is more inexpensive than the single crystal substrate, the cost of manufacturing can be reduced. Further, since these substrates are stable in a reducing atmosphere, they can be heat-treated at high temperature (e.g., about 1000° C. for platinum) in the reducing atmosphere.

Next, at step S2, a separation layer 102 is formed on the substrate 101, as shown in FIG. 2B. The separation layer 102 is a sacrifice layer that is removed when a functional film to be formed at the subsequent process is peeled from the substrate 101. As a material of the separation layer 102, a material that easily fractures by being applied with an external force like a material having cleavage characteristics is used. As such a material, hexagonal boron nitride (h-BN), mica, graphite, transition metal chalcogenide including molybdenum disulfide (MoS₂) and so on are cited. Further, in consideration of process temperature at the subsequent process (e.g., about 350° C. or more), it is desired that a material having heat tolerance is used. As a method of forming the separation layer, a known method such as sputtering and CVD (chemical vapor deposition) methods may be used.

Next, at step S3, a layer to be peeled 103 containing a material of a functional film as a target of manufacturing (functional material) is formed on the separation layer 102, as shown in FIG. 2C. The layer to be peeled 103 is formed by using a known method such as a sputtering method, a CVD method, a sol-gel method and an aerosol deposition (AD) method. Here, the AD method is a film forming method of generating an aerosol in which raw material powder is dispersed in a gas, injecting the aerosol from a nozzle toward a substrate to allow the raw material powder to collide with the under layer, and thereby, depositing the raw material on the substrate, and the method is also called “injection deposition method” or “gas deposition method”.

In the embodiment, specifically, the following materials are used as functional materials.

As a material of a functional film to be used for a memory element, Pb(Zr,Ti)O₃, SrBi₂(Ta,Nb)₂O₉, Bi₄Ti₃O₁₂ and so on are cited.

As a material of a functional film to be used for a piezoelectric element such as an actuator, Pb(Zr,Ti)O₃, Pb(Mg_{1/3}Nb_{2/3})O₃, Pb(Zn_{1/3}Nb_{2/3})O₃, Pb(Ni_{1/3}Nb_{2/3})O₃ and so on, and solid solutions thereof are cited.

As a material of a functional film to be used for a pyroelectric element such as an infrared sensor, Pb(Zr,Ti)O₃, (Pb,La)(Zr,Ti)O₃ and so on are cited.

As a material of a functional film to be used for a passive component such as a capacitor, BaSrTiO₃, (Pb,La)(Zr,Ti)O₃ and so on are cited.

As a material of a functional film to be used for an optical element such as an optical switch, (Pb,La)(Zr,Ti)O₃, LiNbO₃ and so on are cited.

As a material of a functional film to be used for a superconducting element such as a superconducting quantum interference device (SQUID), YBa₂Cu₃O₇, Bi₂Sr₂Ca₂Cu₃O₁₀ and so on are cited. Here, SQUID refers to a highly sensitive magnetic sensor element utilizing superconductivity.

As a material of a functional film to be used for a photoelectric conversion element such as a solar cell, amorphous silicon and compound semiconductor are cited.

As a material of a functional film to be used for a micro magnetic element such as a magnetic head, PdPtMn, CoPtCr and so on are cited.

As a material of a functional film to be used for a semiconductor element such as a TFT, amorphous silicon and so on are cited.

The functional film containing structure according to the embodiment includes the substrate 101, the separation layer 102, and the layer to be peeled 103 formed at those steps S1 to S3.

Subsequently, heat treatment (post anneal) may be performed on the functional film containing structure according to need. This is because the function of the film can be improved by promoting the growth of crystal grain contained in the layer to be peeled (functional film) and improving crystallinity.

Next, at step S4 in FIG. 1, a substrate for transfer 104 is provided on the layer to be peeled 103, as shown in FIG. 2D. In this regard, the substrate for transfer 104 may be fixed to the layer to be peeled 103 by using an adhesive agent 104a or the like. As the substrate for transfer 104, a substrate having a certain degree of elasticity such as a synthetic resin substrate of epoxy or the like is desirably used. Further, electrodes and interconnections may be formed at a side of the substrate for transfer 104 in advance.

Next, at step S5, an external force is applied to the separation layer 102. As a method of applying an external force, for example, the substrate for transfer 104 is relatively displaced or deformed with respect to the separation layer 102. Specifically, as shown in FIG. 2E, the substrate for transfer 104 may be peeled from the substrate 101, or the substrate for transfer 104 may be pulled in the horizontal direction relative to the substrate 101. Thereby, fracture is produced within the separation layer 102 or at an interface thereof, and the layer to be peeled (function film) 103 is peeled from the substrate 101 and transferred to the substrate for transfer 104. Alternatively, the bonding strength between the layer to be peeled 103 and the substrate becomes lower by applying an external force, and thereby, the layer to be peeled 103 can be transferred by further pulling up the substrate for transfer 104.

### EXAMPLE

An h-BN film having a thickness of about 0.5 μm is formed as a separation layer by using boron trichloride (BCl₃) and ammonia (NH₃) as raw materials according to thermal CVD (substrate temperature 1200° C.). A lower electrode of platinum (Pt) is formed on the h-BN film by the sputtering method, and a PZT (lead zirconate titanate) film having a thickness of about 2 μm is formed thereon by the sputtering method. At this time, the substrate is heated to a temperature of about 550° C. Furthermore, an upper electrode of platinum is formed on the PZT film by using the sputtering method, and thereby, a Pt/PZT/Pt piezoelectric element is fabricated.

Then, an adhesive agent is applied onto the upper electrode of the Pt/PZT/Pt piezoelectric element formed on the quartz substrate, and an epoxy substrate is bonded as a substrate for transfer. Further, when the quartz substrate is fixed and an external force is applied to the separation layer by pulling up the epoxy substrate, fracture is produced in the h-BN film as the separation layer, and the Pt/PZT/Pt piezoelectric element is peeled from the quartz substrate and transferred to the epoxy substrate.

As described above, according to the first embodiment of the present invention, the functional film can be easily peeled from the film formation substrate by using a material having cleavage characteristics as the separation layer and applying an external force to the separation layer. Therefore, a functional film formed by using the film formation technology such as a sputtering method and an AD method through predetermined process temperature (e.g., about 350° C. or more) and an element containing such a functional film can be transferred to a desired substrate at relatively low temperature and utilized. That is, since the transfer can be performed to a resin substrate having relatively low heat tolerance, the range of choices of substrates can be expanded to a flexible substrate, for example, according to application.

Further, since the material of the separation layer 102 to be used in the embodiment has relatively high heat tolerance, heat treatment can be performed on the functional film at a high temperature before the transfer process (steps S4 and S5). For example, h-BN is stable in an oxygen atmosphere and has heat tolerance to about 800° C. to 1000° C.). Accordingly, in the case where a PZT film is fabricated by using h-BN as the separation layer, the piezoelectric property of the PZT film can be improved by performing heat treatment at about 800° C., for example.

As a modified example of the functional film containing structure to be used in the manufacturing process of the functional film according to the embodiment, as shown in FIG. 4, a layer to be peeled 105 including an electrode layer 105a and a functional material layer 105b may be formed. Further, as another modified example of the functional film containing structure, as shown in FIG. 5, a layer to be peeled 106 including a functional material layer 106a and an electrode layer 106b may be formed. Furthermore, a layer to be peeled including electrode layers on both of upper and lower surfaces of the functional material layer may be used. The electrode layers 105a and 106b may be formed by a known method such as a sputtering method and an evaporation method.

In the embodiment, at step S5, the layer to be peeled 103 has been transferred to the substrate for transfer 104 at the same time as being peeled from the substrate 101. However, only the peeling of the layer to be peeled 103 may be performed without bonding the substrate for transfer 104. Thereby, a functional film, or a functional element containing a functional film and an electrode can be obtained singly. In this case, an external force may be applied to the separation layer 102 in a way of applying physical stimulation (e.g., impact) onto the side surface of the separation layer and so on.

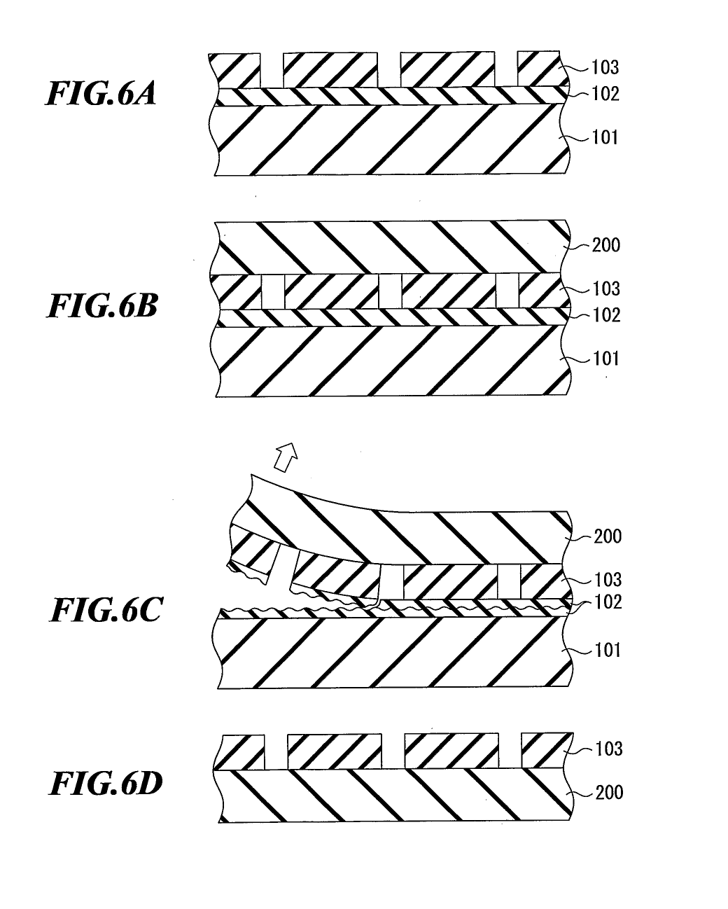

Next, a method of manufacturing a functional film according to the second embodiment will be explained by referring to FIGS. 2A to 2C and FIG. 6A to 6D. The method of manufacturing a functional film according to the embodiment is a method of manufacturing a patterned functional film.

First, as shown in FIGS. 2A to 2C, a functional film containing structure 101 to 103 in which a separation layer 102 and a layer to be peeled 103 are formed on a substrate 101 is fabricated. The method of manufacturing the film containing structure 101 to 103 is the same as that has been explained in the first embodiment.

Then, as shown in FIG. 6A, a pattern is formed on the layer to be peeled 103 by dry etching. In this regard, etching may be performed only on the layer to be peeled 103, or etching may be performed as far as the separation layer 102.

Then, as shown in FIG. 6B, a substrate for transfer 200 is provided on the layer to be peeled 103 on which the pattern has been formed. In this regard, the substrate for transfer 200 may be fixed to the layer to be peeled 103 by using an adhesive agent or the like. Further, as the substrate for transfer 200, a synthetic resin substrate of epoxy or the like is used similarly to the first embodiment.

Further, as shown in FIG. 6C, for example, an external force is applied to the separation layer 102 by pulling up the substrate for transfer 200 while fixing the substrate 101. As a result, as shown in FIG. 6D, fracture is produced within the separation layer 102 or at an interface thereof, and the patterned layer to be peeled (functional film) 103 is peeled from the substrate 101 and transferred to the substrate for transfer 200.

Thus, according to the second embodiment of the present invention, since the pattern has been formed on the layer to be peeled of the functional film containing structure in advance, the functional film or functional film element may be provided on the desired substrate to form a desired pattern. Therefore, an array in which plural functional elements are arranged can be fabricated easily.

In the above explained first and second embodiments of the present invention, an external force may be applied to the separation layer 102 while heating the functional film containing structure. Thereby, fracture is easily produced in the separation layer 102, and the layer to be peeled can be peeled with weaker force. Further, by adjusting the temperature at that time according to the material of the functional film, the improvement in the function of the functional film is expected. In this case, it is necessary to determine the heat treatment temperature in consideration of heat tolerance of the substrate for transfer 104 and the adhesive agent 104a (FIG. 2D).

Alternatively, an external force may be applied to the separation layer 102 while applying electromagnetic wave to the functional film containing structure. For example, since the material contained in the separation layer 102 is activated by being applied with an ultraviolet ray or the separation layer 102 is heated by being applied with an infrared ray or a microwave, fracture can be produced in the separation layer 102 with weaker force. Here, microwave is an electromagnetic wave having a wavelength of about 1 m to 1 mm, and includes UHF wave (decimeter wave), SHF wave (centimeter wave), EHF wave (millimeter wave) and submillimeter wave. In the case of using light such as an ultraviolet ray and an infrared ray, it is desired to use a substrate material that is transparent to the used electromagnetic wave and apply the electromagnetic wave from a side of the substrate 101 to the separation layer 102.

### INDUSTRIAL APPLICABILITY

The present invention can be applied to memory elements, piezoelectric elements, pyroelectric elements, passive elements such as capacitors, optical elements, superconducting elements, photoelectric conversion elements, micro magnetic elements and semiconductor elements containing functional materials such as dielectric materials, piezoelectric materials, pyroelectric materials, magnetic material and semiconductor materials, and instruments to which those elements are applied. A method of manufacturing a functional film by which a functional film formed on a film formation substrate can be easily peeled from the film formation substrate. The method includes the steps of: (a) forming a separation layer on a substrate; (b) forming a layer to be peeled containing a functional film, which is formed by using a functional material, on the separation layer; and (c) applying an external force to the separation layer to produce fracture within the separation layer or at an interface thereof so as to peel the layer to be peeled from the substrate or reduce bonding strength between the layer to be peeled and the substrate.

### TECHNICAL FIELD

The present invention relates to a method of manufacturing a functional film including a dielectric material, piezoelectric material, pyroelectric material, magnetic material, semiconductor material or the like, and a functional film containing structure to be used in a manufacturing process of the functional film.

### BACKGROUND ART

Recent years, in response to the needs for electronic devices such as miniaturization, speeding up, integration, and multifunctionality, the manufacture of devices containing functional materials such as electronic ceramics, which express predetermined functions by being applied with electric fields or magnetic fields and include a dielectric material, piezoelectric material, magnetic material, pyroelectric material and semiconductor material, by using various film formation technologies has been actively studied.

For example, in order to enable high-definition and high-quality printing in an inkjet printer, it is necessary to miniaturize and highly integrate ink nozzles of inkjet heads. Accordingly, it is also necessary to similarly miniaturize and highly integrate piezoelectric actuators for driving the respective ink nozzles. In such a case, a film formation technology, that enables formation of a thinner layer than a bulk material and formation of fine patterns, is desired, and film formation technologies such as a sputtering method, a sol-gel method, and an aerosol deposition method have been studied.

However, there has been a problem that a film of function material (also simply referred to as “functional film”) formed by film formation does not sufficiently exert its function in a condition after the film formation, and the film is inferior to a bulk material in performance.

In order to sufficiently express the function of a functional film, heat treatment at relatively high temperature (e.g., about 500° C. to 1000° C.) is required after film formation. Since a substrate that is used at the time of film formation (film formation substrate) is simultaneously heat-treated, high heat tolerance is required for the material of film formation substrate. On the other hand, in the case where a fabricated function film is utilized, there is demand for using various kinds of substrates according to instruments such as a flexibly substrate made of resin, for example. Accordingly, a method has been studied by which a functional film formed on a film formation substrate can be peeled or transferred from the film formation substrate without hindering its function.

As a related technology, Japanese Patent Application Publication JP-A-54-94905 discloses a multilayered structure for thin film transfer having a heat-resistant substrate, a release layer principally containing carbon and/or carbon compound, and a functional thin film as main component elements (page 1). Further, JP-A-54-94905 discloses that the functional thin film can be peeled from the heat-resistant substrate and transferred to another substrate because the release layer can be removed by oxidization (combustion) (page 3).

Japanese Patent Application Publication JP-A-10-125929 discloses a peeling method by which any material to be peeled can be easily peeled regardless of its properties and conditions, and especially, the peeled material can be transferred to various transfer materials. The peeling method is to peel a material to be peeled existing on a substrate via a separation layer having a multilayered structure of plural layers from the substrate, and includes the steps of applying irradiating light to the separation layer to cause peeling within the layer of the separation layer and/or at an interface thereof so as to detach the material to be peeled from the substrate (pages 1 and 2). Further, in JP-A-10-125929, as the composition of a light absorption layer, amorphous silicon, silicon oxide, dielectric material, nitride ceramics, organic polymer and so on are cited (pages 5 and 6).

Japanese Patent Application Publication JP-P2004-165679A discloses a method of transferring a layer to be transferred containing a thin film device to a secondary transfer material, which method is for matching (i) a multilayer relationship of the layer to be transferred against a substrate used when the layer to be transferred is manufactured and (ii) a multilayer relationship of the layer to be transferred against a transfer material as a transfer destination of the layer to be transferred. The method includes the first step of forming a first separation layer on a substrate, the second step of forming a layer to be transferred containing a thin film device on the first separation layer, the third step of forming a second separation layer consisting of a water-soluble or organic solvent-soluble adhesive agent on the layer to be transferred, the fourth step of bonding a primary transfer material onto the second separation layer, the fifth step of removing the substrate from a material to be transferred by using the first separation layer as a boundary, the sixth step of bonding a secondary transfer material to an undersurface of the layer to be transferred, and the seventh step of bringing the second separation layer into contact with water or organic solvent to remove the primary transfer material from the transfer layer by using the second separation layer as a boundary (pages 1 and 2). Further, in JP-P2004-165679A, as the composition of the separation layer, amorphous silicon, silicon oxide, dielectric material, nitride ceramics, organic polymer and so on are cited (pages 8 and 9).

However, according to JP-A-54-94905, since the release layer is removed by oxidation reaction, the atmosphere in the heat treatment process is limited to an oxygen atmosphere. Further, since carbon or carbon compound is used as the release layer, there is the upper limit to heating temperature. For example, in an embodiment disclosed in JP-A-54-94905 (pages 1 and 3), the treatment temperature in the transfer process is 630° C. at the highest. Therefore, the invention disclosed in JP-A-54-94905 cannot be applied to a manufacture of electronic ceramics that requires heat treatment at relatively high temperature (e.g., 900° C. or more).

According to JP-A-10-125929, peeling is caused within the separation layer by applying a laser beam to a light absorption layer contained in the separation layer to allow the light absorption layer to ablate. Here, “ablation” means that a solid material contained in the light absorption layer is photochemically or thermally excited by absorbing the applied light, and thereby, bonding between atoms or molecules of the surface or inside thereof is cut and they are released. The ablation principally appears as a phenomenon that a phase change such as melting or transpiration (vaporization) occurs in the constituent material of the light absorption layer. According to the method, although the material to be peeled can be peeled from the substrate at relatively low temperature, the peeling property is likely to be insufficient.

On the other hand, according to JP-P2004-165679A, when the thin film device is detached from the substrate by applying a laser beam to the separation layer, in order to peel the thin film device from the substrate more reliably, ions for promoting peeling are implanted into the separation layer. According to such a method, inner pressure is generated in the separation layer and the peeling phenomenon is promoted. However, since hydrogen ions cited as ions for promoting peeling in JP-P2004-165679A are gasified at 350° C. or more and exit from the separation layer (page 6), the process temperature after ion implantation can not be set to 350° C. or more.

### DISCLOSURE OF THE INVENTION

In view of the above-mentioned problems, a first purpose of the present invention is to provide a method of manufacturing a functional film by which a functional film formed on a film formation substrate can be easily peeled from the film formation substrate. Further, a second purpose of the present invention is to provide a functional film containing structure to be used in a manufacturing process of such a functional film.

In order to accomplish the purposes, a functional film containing structure according to one aspect of the present invention includes: a substrate; a separation layer provided on the substrate; and a layer to be peeled provided on the separation layer and containing a functional film formed by using a functional material, wherein the layer to be peeled is peeled from the substrate or bonding strength between the layer to be peeled and the substrate becomes lower by applying an external force to the separation layer to produce fracture within the separation layer or at an interface thereof.

Further, a method of manufacturing a functional film according to one aspect of the present invention includes the steps of: (a) forming a separation layer on a substrate; (b) forming a layer to be peeled containing a functional film, which is formed by using a functional material, on the separation layer; and (c) applying an external force to the separation layer to produce fracture within the separation layer or at an interface thereof so as to peel the layer to be peeled from the substrate or reduce bonding strength between the layer to be peeled and the substrate.

According to the present invention, the separation layer that easily fractures by being applied with an external force is provided between the substrate and the layer to be peeled containing the functional film, and therefore, the substrate and the functional film can be peeled with a little force. Accordingly, the functional film formed on the substrate by using a film formation technology at a relatively higher temperature (e.g., 350° C. or more) can be easily transferred to a flexible substrate or the like having relatively low heat tolerance at a lower temperature (e.g., about 10° C. to 100° C.) and utilized. Therefore, elements having advantageous properties can be suitably mounted on instruments according to application and the performance of the entire instruments utilizing such elements can be improved.

### BRIEF DESCRIPTION OF THE DRAWINGS

Advantages and features of the present invention will be apparent by considering the following detailed description and the drawings in relation. In these drawings, the same reference numerals indicate the same component elements.

FIG. 1 is a flowchart showing a method of manufacturing a functional film according to the first embodiment of the present invention.

FIGS. 2A to 2E are sectional views for explanation of the method of manufacturing a functional film according to the first embodiment of the present invention.

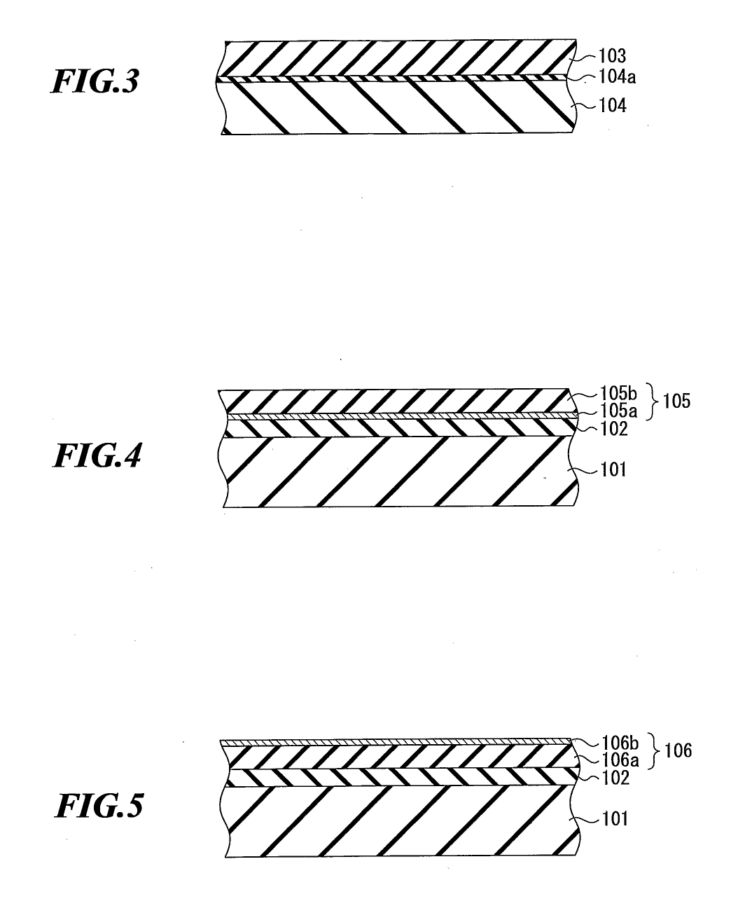

FIG. 3 is a sectional view showing a functional film transferred to a substrate for transfer.

FIG. 4 is a sectional view showing a modified example of a functional film containing structure.

FIG. 5 is a sectional view showing another modified example of the functional film containing structure.

FIGS. 6A to 6D are diagrams for explanation of a method of manufacturing a functional film according to the second embodiment of the present invention.

### BEST MODE FOR CARRYING OUT THE INVENTION

FIG. 1 is a flowchart showing a method of manufacturing a functional film according to the first embodiment of the present invention. Further, FIGS. 2A to 2E are diagrams for explanation of the method of manufacturing a functional film according to the first embodiment of the present invention, in which FIGS. 2A to 2C show steps of fabricating a functional film containing structure according to the first embodiment of the present invention.

First, at step S1 in FIG. 1, a substrate 101 is prepared as shown in FIG. 2A. The substrate 101 is a substrate for film formation to be used in the manufacturing process of the functional film. As the substrate 101, selection is desirably made in consideration of heat tolerance to the process temperature at the subsequent film formation process and the heat treatment process to be performed according to need and so on. For example, a single crystal substrate including a semiconductor single crystal substrate and an oxide single crystal substrate, a ceramic substrate, a glass substrate or a metal substrate is used.

As an oxide single crystal substrate material, specifically, magnesium oxide (MgO), alumina (Al₂O₃), titanium oxide (TiO₂), zinc oxide (ZnO), spinel (magnesium aluminate, MgAl₂O₄), strontium titanate (SrTiO₃), lanthanum aluminate (LaAlO₃), lithium niobate (LiNbO₃), lithium tantalate (LiTaO₃) and so on are cited. In the case where the oxide single crystal substrate material is used, by selecting a material having a predetermined lattice constant according to a functional film as a target of manufacturing, the functional film can be formed by epitaxial growth. Further, since these substrates are stable in an oxidizing atmosphere, they can be used for film formation or heat-treated at high temperature (e.g., about 1000° C. for magnesium oxide) in the air atmosphere.

As a semiconductor single crystal substrate material, specifically, silicon (Si), germanium (Ge), gallium arsenide (GaAs), gallium phosphide (GaP), indium phosphide (InP) and so on are cited. In the case where the semiconductor single crystal substrate material is used, by selecting a material having a predetermined lattice constant according to a functional film as a target of manufacturing, the functional film can be formed by epitaxial growth. Further, since these substrates are stable in a reducing atmosphere, they can be used for film formation or heat-treated at high temperature (e.g., about 1000° C. for silicon) in the reducing atmosphere.

As a ceramic substrate material, alumina (Al₂O₃), zirconia (ZrO₂), aluminum nitride (AlN) and so on are cited. Since the ceramic substrate is more inexpensive than the single crystal substrate, the cost of manufacturing can be reduced. Further, since these substrates are stable in the air atmosphere and have high heat tolerance, they can be used for film formation or heat-treated at high temperature (e.g., about 1100° C. for alumina) in the air atmosphere.

As a glass substrate material, specifically, silicate glass, alkaline silicate glass, borosilicate glass, soda-lime glass, lead glass and so on are cited. Since the glass substrate is more inexpensive than the single crystal substrate, the cost of manufacturing can be reduced. Further, since these substrates are stable in an oxidizing atmosphere, they can be used for film formation or heat-treated at high temperature (e.g., about 900° C. for silicate glass) in the air atmosphere.

As a metal substrate material, specifically, metal such as platinum (Pt), copper (Cu), nickel (Ni), iron (Fe) and so on, and alloy such as stainless are cited. Since the metal substrate is more inexpensive than the single crystal substrate, the cost of manufacturing can be reduced. Further, since these substrates are stable in a reducing atmosphere, they can be heat-treated at high temperature (e.g., about 1000° C. for platinum) in the reducing atmosphere.

Next, at step S2, a separation layer 102 is formed on the substrate 101, as shown in FIG. 2B. The separation layer 102 is a sacrifice layer that is removed when a functional film to be formed at the subsequent process is peeled from the substrate 101. As a material of the separation layer 102, a material that easily fractures by being applied with an external force like a material having cleavage characteristics is used. As such a material, hexagonal boron nitride (h-BN), mica, graphite, transition metal chalcogenide including molybdenum disulfide (MoS₂) and so on are cited. Further, in consideration of process temperature at the subsequent process (e.g., about 350° C. or more), it is desired that a material having heat tolerance is used. As a method of forming the separation layer, a known method such as sputtering and CVD (chemical vapor deposition) methods may be used.

Next, at step S3, a layer to be peeled 103 containing a material of a functional film as a target of manufacturing (functional material) is formed on the separation layer 102, as shown in FIG. 2C. The layer to be peeled 103 is formed by using a known method such as a sputtering method, a CVD method, a sol-gel method and an aerosol deposition (AD) method. Here, the AD method is a film forming method of generating an aerosol in which raw material powder is dispersed in a gas, injecting the aerosol from a nozzle toward a substrate to allow the raw material powder to collide with the under layer, and thereby, depositing the raw material on the substrate, and the method is also called “injection deposition method” or “gas deposition method”.

In the embodiment, specifically, the following materials are used as functional materials.

As a material of a functional film to be used for a memory element, Pb(Zr,Ti)O₃, SrBi₂(Ta,Nb)₂O₉, Bi₄Ti₃O₁₂ and so on are cited.

As a material of a functional film to be used for a piezoelectric element such as an actuator, Pb(Zr,Ti)O₃, Pb(Mg_{1/3}Nb_{2/3})O₃, Pb(Zn_{1/3}Nb_{2/3})O₃, Pb(Ni_{1/3}Nb_{2/3})O₃ and so on, and solid solutions thereof are cited.

As a material of a functional film to be used for a pyroelectric element such as an infrared sensor, Pb(Zr,Ti)O₃, (Pb,La)(Zr,Ti)O₃ and so on are cited.

As a material of a functional film to be used for a passive component such as a capacitor, BaSrTiO₃, (Pb,La)(Zr,Ti)O₃ and so on are cited.

As a material of a functional film to be used for an optical element such as an optical switch, (Pb,La)(Zr,Ti)O₃, LiNbO₃ and so on are cited.

As a material of a functional film to be used for a superconducting element such as a superconducting quantum interference device (SQUID), YBa₂Cu₃O₇, Bi₂Sr₂Ca₂Cu₃O₁₀ and so on are cited. Here, SQUID refers to a highly sensitive magnetic sensor element utilizing superconductivity.

As a material of a functional film to be used for a photoelectric conversion element such as a solar cell, amorphous silicon and compound semiconductor are cited.

As a material of a functional film to be used for a micro magnetic element such as a magnetic head, PdPtMn, CoPtCr and so on are cited.

As a material of a functional film to be used for a semiconductor element such as a TFT, amorphous silicon and so on are cited.

The functional film containing structure according to the embodiment includes the substrate 101, the separation layer 102, and the layer to be peeled 103 formed at those steps S1 to S3.

Subsequently, heat treatment (post anneal) may be performed on the functional film containing structure according to need. This is because the function of the film can be improved by promoting the growth of crystal grain contained in the layer to be peeled (functional film) and improving crystallinity.

Next, at step S4 in FIG. 1, a substrate for transfer 104 is provided on the layer to be peeled 103, as shown in FIG. 2D. In this regard, the substrate for transfer 104 may be fixed to the layer to be peeled 103 by using an adhesive agent 104a or the like. As the substrate for transfer 104, a substrate having a certain degree of elasticity such as a synthetic resin substrate of epoxy or the like is desirably used. Further, electrodes and interconnections may be formed at a side of the substrate for transfer 104 in advance.

Next, at step S5, an external force is applied to the separation layer 102. As a method of applying an external force, for example, the substrate for transfer 104 is relatively displaced or deformed with respect to the separation layer 102. Specifically, as shown in FIG. 2E, the substrate for transfer 104 may be peeled from the substrate 101, or the substrate for transfer 104 may be pulled in the horizontal direction relative to the substrate 101. Thereby, fracture is produced within the separation layer 102 or at an interface thereof, and the layer to be peeled (function film) 103 is peeled from the substrate 101 and transferred to the substrate for transfer 104. Alternatively, the bonding strength between the layer to be peeled 103 and the substrate becomes lower by applying an external force, and thereby, the layer to be peeled 103 can be transferred by further pulling up the substrate for transfer 104.

### EXAMPLE

An h-BN film having a thickness of about 0.5 μm is formed as a separation layer by using boron trichloride (BCl₃) and ammonia (NH₃) as raw materials according to thermal CVD (substrate temperature 1200° C.). A lower electrode of platinum (Pt) is formed on the h-BN film by the sputtering method, and a PZT (lead zirconate titanate) film having a thickness of about 2 μm is formed thereon by the sputtering method. At this time, the substrate is heated to a temperature of about 550° C. Furthermore, an upper electrode of platinum is formed on the PZT film by using the sputtering method, and thereby, a Pt/PZT/Pt piezoelectric element is fabricated.

Then, an adhesive agent is applied onto the upper electrode of the Pt/PZT/Pt piezoelectric element formed on the quartz substrate, and an epoxy substrate is bonded as a substrate for transfer. Further, when the quartz substrate is fixed and an external force is applied to the separation layer by pulling up the epoxy substrate, fracture is produced in the h-BN film as the separation layer, and the Pt/PZT/Pt piezoelectric element is peeled from the quartz substrate and transferred to the epoxy substrate.

As described above, according to the first embodiment of the present invention, the functional film can be easily peeled from the film formation substrate by using a material having cleavage characteristics as the separation layer and applying an external force to the separation layer. Therefore, a functional film formed by using the film formation technology such as a sputtering method and an AD method through predetermined process temperature (e.g., about 350° C. or more) and an element containing such a functional film can be transferred to a desired substrate at relatively low temperature and utilized. That is, since the transfer can be performed to a resin substrate having relatively low heat tolerance, the range of choices of substrates can be expanded to a flexible substrate, for example, according to application.

Further, since the material of the separation layer 102 to be used in the embodiment has relatively high heat tolerance, heat treatment can be performed on the functional film at a high temperature before the transfer process (steps S4 and S5). For example, h-BN is stable in an oxygen atmosphere and has heat tolerance to about 800° C. to 1000° C.). Accordingly, in the case where a PZT film is fabricated by using h-BN as the separation layer, the piezoelectric property of the PZT film can be improved by performing heat treatment at about 800° C., for example.

As a modified example of the functional film containing structure to be used in the manufacturing process of the functional film according to the embodiment, as shown in FIG. 4, a layer to be peeled 105 including an electrode layer 105a and a functional material layer 105b may be formed. Further, as another modified example of the functional film containing structure, as shown in FIG. 5, a layer to be peeled 106 including a functional material layer 106a and an electrode layer 106b may be formed. Furthermore, a layer to be peeled including electrode layers on both of upper and lower surfaces of the functional material layer may be used. The electrode layers 105a and 106b may be formed by a known method such as a sputtering method and an evaporation method.

In the embodiment, at step S5, the layer to be peeled 103 has been transferred to the substrate for transfer 104 at the same time as being peeled from the substrate 101. However, only the peeling of the layer to be peeled 103 may be performed without bonding the substrate for transfer 104. Thereby, a functional film, or a functional element containing a functional film and an electrode can be obtained singly. In this case, an external force may be applied to the separation layer 102 in a way of applying physical stimulation (e.g., impact) onto the side surface of the separation layer and so on.

Next, a method of manufacturing a functional film according to the second embodiment will be explained by referring to FIGS. 2A to 2C and FIG. 6A to 6D. The method of manufacturing a functional film according to the embodiment is a method of manufacturing a patterned functional film.

First, as shown in FIGS. 2A to 2C, a functional film containing structure 101 to 103 in which a separation layer 102 and a layer to be peeled 103 are formed on a substrate 101 is fabricated. The method of manufacturing the film containing structure 101 to 103 is the same as that has been explained in the first embodiment.

Then, as shown in FIG. 6A, a pattern is formed on the layer to be peeled 103 by dry etching. In this regard, etching may be performed only on the layer to be peeled 103, or etching may be performed as far as the separation layer 102.

Then, as shown in FIG. 6B, a substrate for transfer 200 is provided on the layer to be peeled 103 on which the pattern has been formed. In this regard, the substrate for transfer 200 may be fixed to the layer to be peeled 103 by using an adhesive agent or the like. Further, as the substrate for transfer 200, a synthetic resin substrate of epoxy or the like is used similarly to the first embodiment.

Further, as shown in FIG. 6C, for example, an external force is applied to the separation layer 102 by pulling up the substrate for transfer 200 while fixing the substrate 101. As a result, as shown in FIG. 6D, fracture is produced within the separation layer 102 or at an interface thereof, and the patterned layer to be peeled (functional film) 103 is peeled from the substrate 101 and transferred to the substrate for transfer 200.

Thus, according to the second embodiment of the present invention, since the pattern has been formed on the layer to be peeled of the functional film containing structure in advance, the functional film or functional film element may be provided on the desired substrate to form a desired pattern. Therefore, an array in which plural functional elements are arranged can be fabricated easily.

In the above explained first and second embodiments of the present invention, an external force may be applied to the separation layer 102 while heating the functional film containing structure. Thereby, fracture is easily produced in the separation layer 102, and the layer to be peeled can be peeled with weaker force. Further, by adjusting the temperature at that time according to the material of the functional film, the improvement in the function of the functional film is expected. In this case, it is necessary to determine the heat treatment temperature in consideration of heat tolerance of the substrate for transfer 104 and the adhesive agent 104a (FIG. 2D).

Alternatively, an external force may be applied to the separation layer 102 while applying electromagnetic wave to the functional film containing structure. For example, since the material contained in the separation layer 102 is activated by being applied with an ultraviolet ray or the separation layer 102 is heated by being applied with an infrared ray or a microwave, fracture can be produced in the separation layer 102 with weaker force. Here, microwave is an electromagnetic wave having a wavelength of about 1 m to 1 mm, and includes UHF wave (decimeter wave), SHF wave (centimeter wave), EHF wave (millimeter wave) and submillimeter wave. In the case of using light such as an ultraviolet ray and an infrared ray, it is desired to use a substrate material that is transparent to the used electromagnetic wave and apply the electromagnetic wave from a side of the substrate 101 to the separation layer 102.

### INDUSTRIAL APPLICABILITY

The present invention can be applied to memory elements, piezoelectric elements, pyroelectric elements, passive elements such as capacitors, optical elements, superconducting elements, photoelectric conversion elements, micro magnetic elements and semiconductor elements containing functional materials such as dielectric materials, piezoelectric materials, pyroelectric materials, magnetic material and semiconductor materials, and instruments to which those elements are applied.

1. A functional film containing structure comprising:
a substrate;
a separation layer provided on said substrate; and
a layer to be peeled provided on said separation layer and containing a functional film formed by using a functional material;
wherein said layer to be peeled is peeled from said substrate or bonding strength between said layer to be peeled and said substrate becomes lower by applying an external force to said separation layer to produce fracture within said separation layer or at an interface thereof.

2. The functional film containing structure according to claim 1, wherein said separation layer contains a material having cleavage characteristics.

3. The functional film containing structure according to claim 2, wherein said separation layer contains boron nitride.

4. The functional film containing structure according to claim 2, wherein said separation layer contains at least one of mica, graphite, and transition metal chalcogenide including molybdenum disulfide (MoS₂).

5. The functional film containing structure according to claim 1, wherein said substrate includes one of a single crystal substrate, which includes one of an oxide single crystal substrate and a semiconductor single crystal substrate, and a ceramic substrate, a glass substrate and a metal substrate.

6. The functional film containing structure according to claim 1, wherein said functional film contains at least one of a piezoelectric material, a pyroelectric material and a ferroelectric material.

7. The functional film containing structure according to claim 1, wherein said functional film contains a superconducting material.

8. The functional film containing structure according to claim 1, wherein said functional film contains a magnetic material.

9. The functional film containing structure according to claim 1, wherein said functional film contains a semiconductor material.

10. The functional film containing structure according to claim 1, wherein said layer to be peeled includes the functional film and at least one electrode layer formed on at least one of an upper surface and a lower surface of said functional film.

11. The functional film containing structure according to claim 1, wherein a predetermined pattern is formed in at least said layer to be peeled.

12. A method of manufacturing a functional film, said method comprising the steps of:
(a) forming a separation layer on a substrate;
(b) forming a layer to be peeled containing a functional film, which is formed by using a functional material, on said separation layer; and
(c) applying an external force to said separation layer to produce fracture within said separation layer or at an interface thereof so as to peel said layer to be peeled from said substrate or reduce bonding strength between said layer to be peeled and said substrate.

13. The method of manufacturing a functional film according to claim 12, wherein said separation layer contains a material having cleavage characteristics.

14. The method of manufacturing a functional film according to claim 13, wherein said separation layer contains boron nitride.

15. The method of manufacturing a functional film according to claim 13, wherein said separation layer contains at least one of mica, graphite, and transition metal chalcogenide including molybdenum disulfide (MoS₂).

16. The method of manufacturing a functional film according to claim 12, wherein said substrate includes one of a single crystal substrate, which includes one of an oxide single crystal substrate and a semiconductor single crystal substrate, and a ceramic substrate, a glass substrate and a metal substrate.

17. The method of manufacturing a functional film according to claim 12, wherein said functional film contains at least one of a piezoelectric material, a pyroelectric material and a ferroelectric material.

18. The method of manufacturing a functional film according to claim 12, wherein said functional film contains a superconducting material.

19. The method of manufacturing a functional film according to claim 12, wherein said functional film contains a magnetic material.

20. The method of manufacturing a functional film according to claim 12, wherein said functional film contains a semiconductor material.

21. The method of manufacturing a functional film according to claim 12, wherein step (b) includes forming an electrode layer on said separation layer, and forming the functional film on said electrode layer.

22. The method of manufacturing a functional film according to claim 12, wherein step (b) includes forming an electrode layer on the functional film formed directly or indirectly on said separation layer.

23. The method of manufacturing a functional film according to claim 12, further comprising the step of:
(b′) providing a second substrate on said layer to be peeled prior to step (c);
wherein step (c) includes applying the external force to said separation layer by relatively displacing or deforming said second substrate with respect to said first substrate.

24. The method of manufacturing a functional film according to claim 23, wherein step (b′) includes fixing said second substrate to said layer to be peeled by using an adhesive agent.

25. The method of manufacturing a functional film according to claim 23, further comprising the step of:
forming a pattern in at least said layer to be peeled by etching prior to step (b′);
wherein step (c) includes applying the external force to said separation layer so as to transfer said layer to be peeled having the pattern to said second substrate.
